(19) United States
(12) Patent Application Publication
(10) Pub. No.: US 2017/0256126 A1
(43) Pub. Date: Sep. 7, 2017

(54) SLOT MACHINE

(71) Applicants: Juichi KIMURA, Tokyo (JP); Juntak JEON, Tokyo (JP)

(72) Inventors: Juichi KIMURA, Tokyo (JP); Juntak JEON, Tokyo (JP)

(21) Appl. No.: 15/449,060

(22) Filed: Mar. 3, 2017

(30) Foreign Application Priority Data
Mar. 4, 2016 (JP) 2016-042731

(51) Int. Cl. G07F 17/32; G07F 17/34

(52) U.S. Cl. CPC G07F 17/3213; G07F 17/3209; G07F 17/34; G07F 17/3244

(57) ABSTRACT

There is provided a slot machine capable of providing a player with a new type of amusement via an intuitive operation, as a result of interlocking between the touch panel and mechanism. A slot machine 1 that determines hitting of a prize according to an arrangement of a plurality of symbols in a regular game, includes: a special game control unit for controlling a special game which is started with winning a prize in the regular game as a trigger; a fixed display 62 for displaying the special game; a movable overlapping unit 63 provided in front of the fixed display 62; a touch panel 61 provided in the nearest side of a player; and an interlocking control unit for interlocking the overlapping unit 63 in accordance with a specific input operation to the touch panel 61, and the movement of the overlapping unit 63 by the specific input operation and display of the special game by the fixed display 62 are synchronized with each other.

### BACKGROUND OF THE INVENTION

Field of the Invention

The present invention relates to a slot machine that determines hitting of a prize according to an arrangement of a plurality of symbols in a regular game.

Description of the Related Art

Conventionally, there are known game machines that produce a game by overlapping a shielding member on the main screen. For example, a game machine disclosed in Patent Literature 1 has provided therein a liquid crystal display and an EL display for displaying various images for presentation, the EL display being configured to be movable relative to a game board by a player's pressing down any of peripheral keys. Further, when the EL display moves a character being displayed on the liquid crystal display to a visible position, text information (text image) indicating an explanation relating to the character is displayed on the EL display.

In addition, a game machine disclosed in Patent Literature 2 sends wind to sheet-like shielding means that shields the screen of an image display device so as to shake the shielding means, thereby providing a player with an opportunity to peek at a part of the screen of the image display device.

### PRIOR ART LITERATURE

### Patent Literature

Patent Literature 1: Japanese Patent Laid-Open No. 2011-239956

Patent Literature 2: Japanese Patent Laid-Open No. 2009-66140

### Problem to be Solved by the Invention

However, the game machine disclosed in Patent Literature 1, which is intended to move the sub-screen by key operation in order to merely view an explanation of a character being displayed, does not allow the shield to be turned over for viewing a hidden object. The game machine disclosed in Patent Literature 2 effectively uses a hidden display for presentation, but is not intended to provide the player with an actual feeling of operation to improve the amusement of the game.

### SUMMARY OF THE INVENTION

It is an object of the present invention, which has been made in view of the aforementioned circumstances, to provide a slot machine capable of providing a player with a new type of amusement via an intuitive operation, as a result of interlocking between the touch panel and mechanism.

In order to achieve the above-described object, a slot machine of the present invention is a slot machine that determines hitting of a prize according to an arrangement of a plurality of symbols in a regular game, the slot machine including: a special game control unit configured to control a special game which is started with winning a prize in the regular game as a trigger; a fixed display configured to display the special game; a movable overlapping unit provided in front of the fixed display; a touch panel provided in front of a player; and an interlocking control unit configured to interlock the overlapping unit in accordance with a specific input operation to the touch panel, wherein the movement of the overlapping unit by the specific input operation and display of the special game by the fixed display are synchronized with each other. As a result of such interlocking between the touch screen and mechanism, the player is provided with a new type of amusement via an intuitive operation.

According to the present invention, the player is provided with a new type of amusement via an intuitive operation, as a result of interlocking between the touch panel and mechanism.

### BRIEF DESCRIPTION OF THE DRAWINGS

FIG. 1 is a perspective view illustrating an exemplary appearance of a slot machine of a first embodiment.

FIG. 2 is a block diagram illustrating an electrical configuration of the slot machine of the first embodiment.

FIGS. 3A to 3C are a front view, a side cross-sectional view, and a rear view, respectively, of a display unit.

FIGS. 4A and 4B are a front cross-sectional view and a rear cross-sectional view, respectively, of the display unit.

FIGS. 5A and 5B respectively illustrate an exemplary movement module.

FIG. 6 is a flowchart illustrating a basic operation of the slot machine of the first embodiment.

FIG. 7 is a flowchart illustrating an operation of a JACKPOT game.

FIG. 8 is a flowchart illustrating an operation of interlocking a movable display.

FIGS. 9A and 9B respectively illustrate an exemplary operation of interlocking the movable display.

FIG. 10 is a flowchart illustrating an operation of a bonus process.

FIG. 11 is a flowchart illustrating an operation of shutter gimmick interlocking.

FIGS. 12A and 12B respectively illustrate an exemplary operation of shutter gimmick interlocking.

FIGS. 13A to 13D respectively illustrate an exemplary operation using a fan-shaped shield of a second embodiment.

FIGS. 14A to 14D respectively illustrate an exemplary operation using a figure of a third embodiment.

FIGS. 15A to 15C respectively illustrate an exemplary operation of a bonus game of a fourth embodiment.

FIGS. 16A to 16D respectively illustrate an exemplary operation using a movable display with LEDs of a fifth embodiment.

### DETAILED DESCRIPTION OF THE INVENTION

Embodiments of the present invention is described in the followings, referring to the accompanying drawings. To facilitate understanding of descriptions, identical components are provided with identical reference numerals for all of the drawings, with duplicate description being omitted.

### First Embodiment

(Configuration of Slot Machine)

(1) Overall Configuration

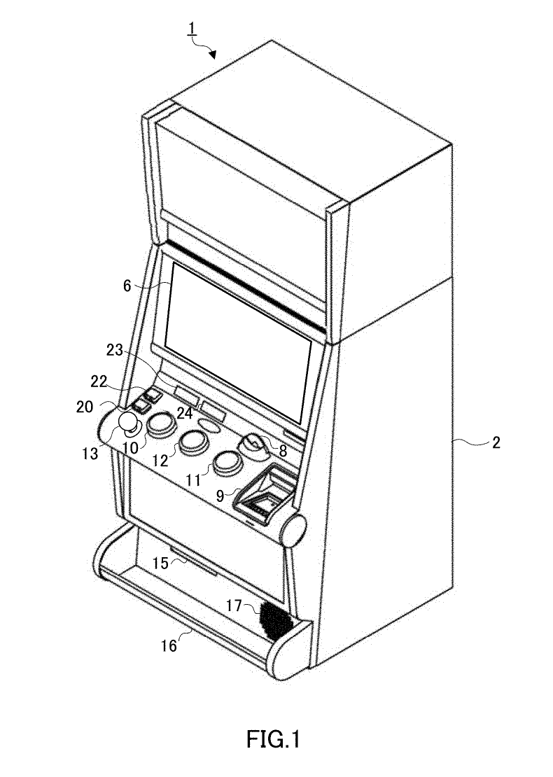

FIG. 1 is a perspective view illustrating an exemplary appearance of a slot machine 1. The slot machine 1 is a so-called video reel slot machine which controls change or stopping of symbols using video reels displayed on a display unit 6. In a regular game, the slot machine 1 displays spinning of reels on which a plurality of symbols is arranged, and determines winning of a prize. Note that, in the following description, a “hit” indicates a state of hitting a prize as a result of processing by a control unit, whereas a “win” refers to a state in which the player has actually acquired the prize after the hit.

Additionally, in the following description, the arrangement is specified in a direction seen from the player, with the side of the display unit 6 of the slot machine 1 being referred to as “top”, the side of a coin receiving tray 16 as “bottom”, the side of a spin lever 13 as “left”, and the side of a bill insertion slot 9 as “right”.

The slot machine 1 includes a housing 2 and a main body unit provided inside the housing 2. The main body unit has the display unit 6 provided thereon so that display of a game is visible from the front side of the housing 2. The display unit 6 has a touch panel, a fixed display, a movable display, and a shutter.

The front side of the housing 2 has a coin insertion slot 8 and the bill insertion slot 9 provided thereon. A bet button 10 is a button that spends a predetermined number of coins retained (credited) in a coin retaining device (deposition unit) which is not illustrated, and a MAX-bet button 11 is a button for spending a predetermined maximum number of coins retained in the coin retaining device which is not illustrated. A spin button 12 is a button for starting display of changing symbols on the display unit 6. The spin lever 13 also has a similar function.

The display unit 6 displays not only a column of symbols but also a guidance of how to operate a game, a bingo ball when playing a special game, and the like. Any of a liquid crystal display, a CRT, an organic EL display, or the like may be used for the fixed display and the movable display.

The fixed display performs display as an operation in a regular game or a special game. For example, the fixed display displays hitting or losing of a prize in the special game. The movable display, which operates as an overlapping unit, is provided to be movable on the front side of the fixed display.

It is preferred that the movable display guides and displays to the player the input operation for movement. Accordingly, the player may easily move the movable display. The convenience for the player thus improves, thereby smoothing the progress of the game.

The overlapping unit may be a shielding unit formed by one or more board members which do not display by themselves. The shielding unit may include, for example, a shutter, a folding fan, or the like as is described below. Therefore, it becomes possible to form an overlapping unit in accordance with the game and perform presentation in accordance with the game. In addition, it is possible to configure an overlapping unit with a simple structure.

A touch panel is provided in front of the player. The player may perform an input operation from the touch panel when playing a special game and, for example, may move the movable display to expose the display by the fixed display. Accordingly, the player may turn over the fixed display by his/her own touch operation to view the result of the special game. Note that details of the configuration of the display unit 6 is described below.

The lower front side of the housing 2 has provided thereon a coin payout slot 15, the coin receiving tray 16, and a loud speaker 17. An payout button 20 is a button for paying out the retained coins. A help button 22 has a function of displaying, on a fixed display 62, manner of playing, payoffs, or the like. A number-of-payout-coins display unit displays the number of coins to be paid out. A number-of-retained-coins display unit 24 displays the number of coins retained in the coin retaining device which is not illustrated. LED or liquid crystal, for example, may be used for the number-of-payout-coins display unit 23 and the number-of-retained-coins display unit 24.

(2) Functional Configuration

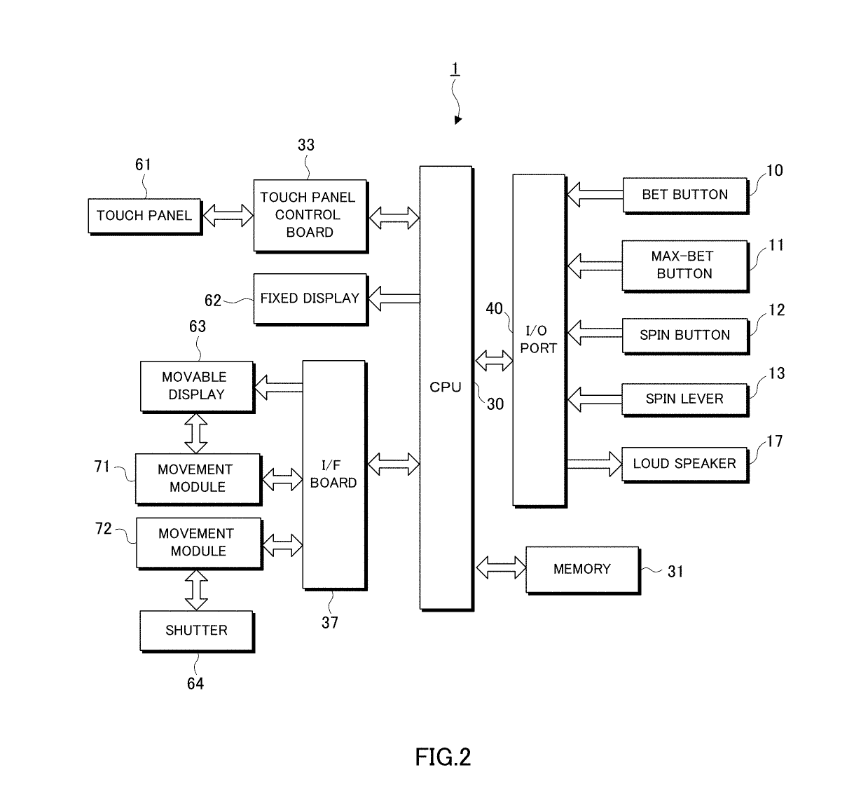

FIG. 2 is a block diagram illustrating an electrical configuration of the slot machine 1. The main body unit of the slot machine 1 has a CPU 30, a memory 31 including a ROM and a RAM, and an I/O port 40. The CPU 30 performs a control operation in accordance with a preset program. For example, the CPU 30 functions as a random number generation unit which receives a start signal and generates a random number or a combination of random numbers, respectively, corresponding to a column of symbols. In addition, the CPU 30 functions as a hit determination unit which determines hitting of a prize by determining an arrangement of a plurality of symbols corresponding to the generated random number or combination of random numbers.

These functions are performed by execution of programs. The memory 31 has stored therein, a control program for controlling the operation of the slot machine 1, various visual effect programs, a symbol column table, a hit table, a plurality of types of element data to be used as elements of image data. The memory 31 functions as a storage unit.

The CPU 30 is connected to the bet button 10, the MAX-bet button 11, the spin button 12, the spin lever 13, and the loud speaker 17 via the I/O port 40. Signals output from the bet button 10 and the spin button 12 are input to the CPU 30 via the I/O port 40. The spin button 12 and the spin lever 13 function as an activation unit which generates a start signal.

The CPU 30 has at least functions of a regular game control unit, a special game control unit, and an interlocking control unit. The regular game control unit displays change of a plurality of symbols in a regular game to display spinning of reels, and also determines hitting of a prize. A special game control unit controls a special game which is started with winning a prize in the regular game as a trigger. When the display by the fixed display 62 which has been hidden behind the overlapping unit is exposed, the special game control unit displays presentation of winning or losing a prize in a special game on the fixed display 62.

An exemplary special game is described later. The interlocking control unit interlocks the overlapping unit in accordance with a specific input operation to a touch panel 61. Input to the touch panel 61 is transmitted to the CPU 30 via a touch panel control board 33. The slot machine 1 synchronizes the movement of the overlapping unit by the specific input operation with the display by the fixed display 62 and executes the special game. As a result of such interlocking between the touch panel 61 and mechanism, the player is provided with a new type of amusement via an intuitive operation.

The interlocking control unit determines whether or not a position on the touch panel 61 touched by the player is within a region occupied by the overlapping unit and, when the position is within the region, causes the overlapping unit to follow the movement of the touch position. Accordingly, the player can perform an intuitive operation such as touching the overlapping unit to move it, thereby improving the player's operability.

The interlocking control unit may change the interlocking control of the overlapping unit in accordance, with the touch operation. For example, when the player's finger is moved slowly upward or downward while touching the touch panel, the overlapping unit is interlocked to move by the same distance in the same direction as the finger. Alternatively, when the player's finger is moved quickly upward or downward while touching the touch panel 61, the overlapping unit can be interlocked to move as far as the upper limit distance in the same direction as the finger.

The fixed display 62 outputs image data which has been sent from the CPU 30. The fixed display 62 may perform image processing to display texts, still images, video images, or the like. The fixed display displays special games as well as regular games.

A movable display 63 is controlled by the CPU 30 via an interface board 37 and a movement module 71. A shutter 64 is controlled by the CPU 30 via the interface board 37 and a movement module 72.

When the touch panel 61 has detected a contact by a finger under a particular condition such as when playing a JACKPOT game, XY coordinates on the screen surface are specified and, when the coordinates are within the range occupied by the movable display 63, the movement of the touching finger is reflected to the movement of the movable display 63 and a signal is output to cause the movable display 63 to move mechanically as much as the amount of movement of the finger. On this occasion, the movable display 63 is interlocked to move only in a particular direction (for example, upward).

(3) Configuration of Display Unit 6

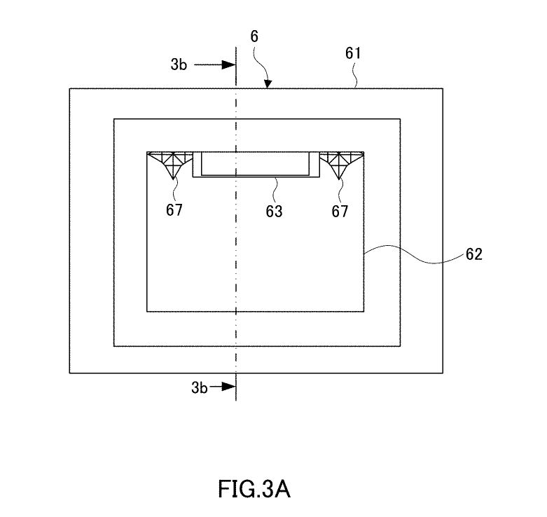

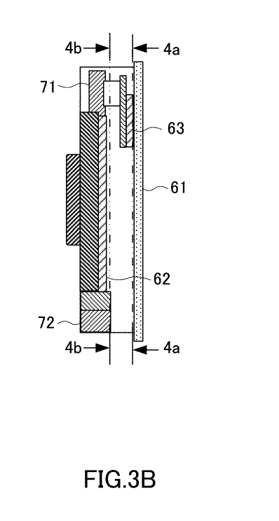

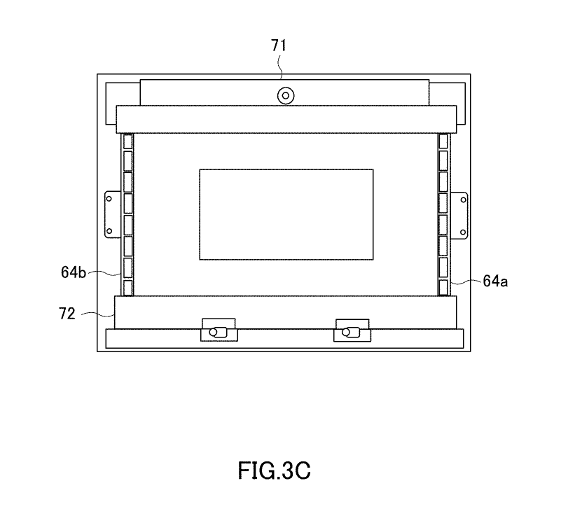

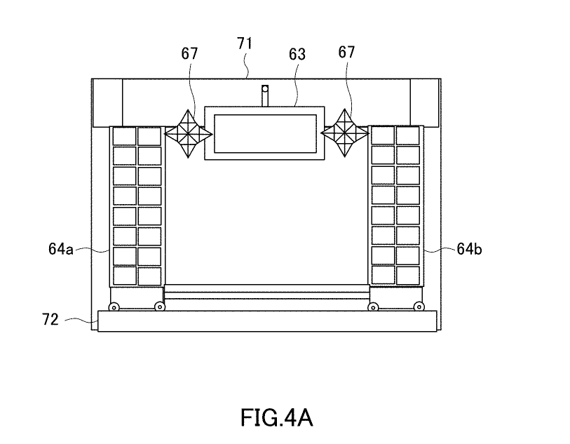

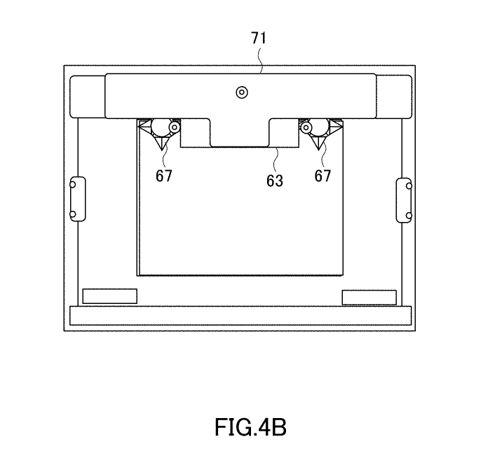

FIGS. 3A to 3C are a front view, a side cross-sectional view, and a rear view, respectively, of a display unit 6. FIGS. 4A and 4B are a front cross-sectional view and a rear cross-sectional view, respectively, of the display unit 6. The cross-sections 3b, 4a and 4b in the drawings express cross-sections of FIGS. 3B, 4A and 4B, respectively.

The touch panel 61 is provided in the display unit 6 on the side closest to the player. The movable display 63 is provided directly after the touch panel 61, and supported in the vertical direction in a state of being suspended by the movement module 71. The movable display 63, in action, moves to the center and retracts upward.

The movement module 71 has a slide mechanism which moves the movable display 63 in a particular direction, and a stepping motor which powers the movement of the slide. When a signal for moving or stopping the movable display 63 is input to the stepping motor, the movable display 63 moves in the particular direction.

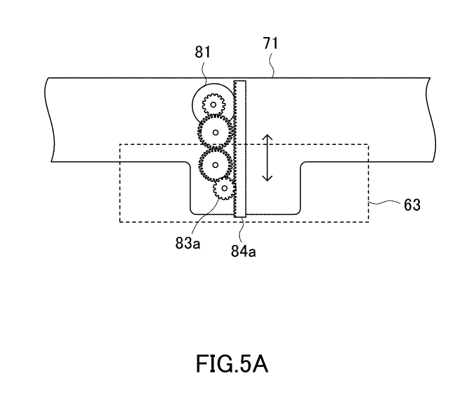

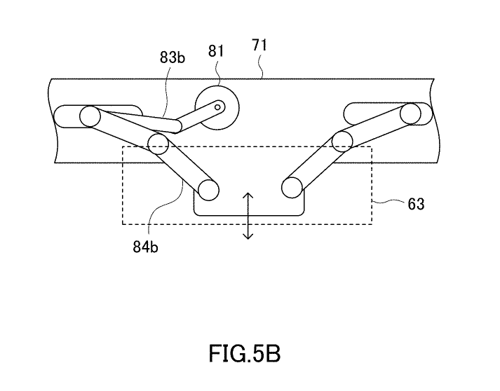

FIGS. 5A and 5B respectively illustrate an example of the movement module 71. In FIGS. 5A and 5B, the movable display 63 is expressed by a dashed line to facilitate viewing of the mechanism. The movement module 71 has a conversion mechanism from rotational motion to linear motion, whereby rotational displacement of the stepping motor is converted to vertical linear displacement of the movable display 63. For example, it is preferred to use a rack-and-pinion mechanism for the conversion mechanism as illustrated in FIG. 5A. It is possible to convert the rotational displacement caused by a stepping motor 81 to linear displacement of a rack 84a which is a toothed flat-plate rod, via a pinion 83a which is a small-diameter circular gear, so as to move the movable display 63 vertically. Such a motion conversion mechanism allows the movable display 63 to be moved efficiently following the movement of the player's finger.

In addition, as illustrated in FIG. 5B, the rotational displacement caused by the stepping motor 81 can be converted to lateral linear displacement by a coupling member 83b coupled with a joint, and further converted to vertical linear displacement of the movable display 63 by a coupling member 84b. Such an approximate linear motion mechanism may be employed, or a slider crank mechanism may be employed.

As illustrated in FIGS. 3A to 3C, the movable display 63 is usually (except when a bingo game is being performed) provided at a retracted position on the upper part in the front view together with a rotational body 67. The rotational body 67 rotates and performs presentation when a particular event occurs. Shutters 64a and 64b are provided slidably in a lateral direction, being supported by the movement module 72 from below.

In addition, the right and left shutters 64a and 64b are respectively formed by two plate-shaped members. When being closed, the shutters 64a and 64b are shifted until the two plate-like members no longer overlap with each other, so as to cover the fixed display 62. When being opened, the two plate-like members overlap with each other, so that the shutter 64a retracts to the left end and the shutter 64b retracts to the right end, respectively. A semitransparent material can be used for the shutters 64a and 64b, whereby the outline of the display by the fixed display 62 becomes visible and the stage effect can be enhanced.

(Operation of Slot Machine)

Next, an operation of the slot machine 1 configured as described above is described. First, an operation of a regular game is mainly described as a basic operation, and an operation when playing a special game such as JACKPOT or a bonus game is described.

(1) Basic Operation

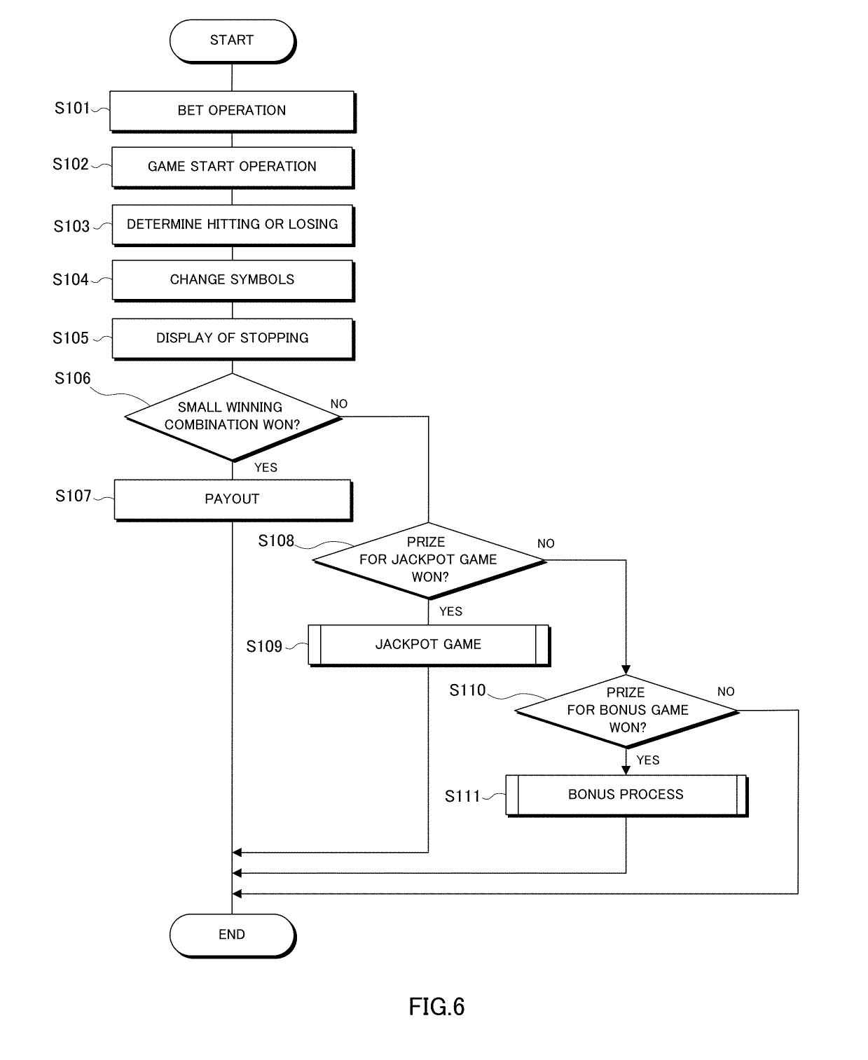

FIG. 6 is a flowchart illustrating a basic operation of the slot machine 1. First, upon accepting a player's bet operation (Step S101), the slot machine 1 transitions to an activatable state. Subsequently, the slot machine 1 accepts a start operation of a regular game such as pressing a spin button or pulling a spin lever (Step S102). In a regular game, hitting of a prize is determined according to an arrangement of a plurality of symbols. When the regular game is started, the regular game control unit, while drawing a lottery to determine hitting or losing (Step S103), controls display of spinning reels by changing symbols (Step S104).

Next, the slot machine 1 stops displaying change of symbols (Step S105). The symbols may be stopped when a stop operation via a stop button is received, or may be automatically stopped after a predetermined time period has elapsed. When a hit is determined by an internal lottery and a predetermined combination of symbols is displayed as one of winning combinations at the time of stopping, the player wins a prize in accordance with the combination of symbols.

First, the slot machine 1 determines whether or not a small winning combination is won according to an arrangement of stopped symbols (Step S106). When a small winning combination is won, the slot machine 1 makes a payout for winning the small winning combination (Step S107), and terminates the game. When no small winning combination is won, it is determined whether or not a prize is won in a JACKPOT game (Step S108).

When a prize is won in the JACKPOT game, the slot machine 1 executes a JACKPOT game described below (Step S109), and terminates the game. When no prize is won in the JACKPOT game, the slot machine 1 determines whether or not a prize is won in a bonus game (Step S110). When a prize is won in the bonus game, the slot machine 1 executes a bonus game described below (Step S111), and terminates the game.

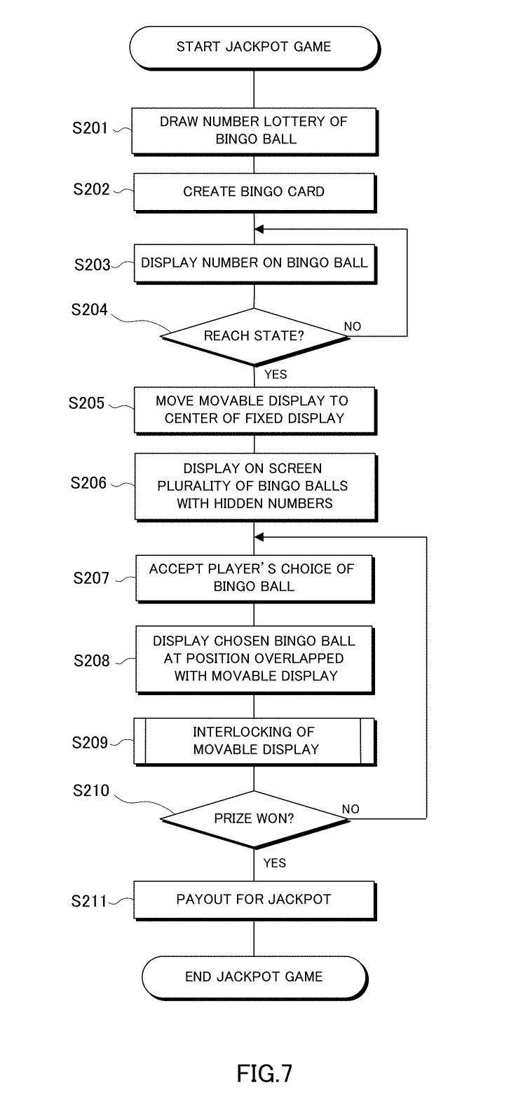

(2) Operation when Playing JACKPOT Game FIG. 7 is a flowchart illustrating an operation in a JACKPOT game. When a JACKPOT game is started, the special game control unit first draws a number lottery of bingo balls (Step S201) and creates a bingo card (Step S202). The special game control unit then displays a number on a bingo ball (Step S203), and determines whether or not the bingo game has entered a reach state (one more to go) (Step S204).

In a case where a reach state has not been entered, the process flow returns to Step S203 to display the number of the next bingo ball. When a reach state is entered, the special game control unit moves the movable display to the center of the fixed display (Step S205), and displays on the screen a plurality of bingo balls with hidden numbers (Step S206).

Subsequently, the special game control unit accepts the player's choice of a bingo ball (Step S207), and displays the chosen bingo ball in a manner moving to the position overlapping with the movable display (Step S208). Next, the special game control unit performs an operation to interlock the player's operation with the movable display (Step S209), and exposes the bingo ball which has been displayed behind the turned-over movable display.

The special game control unit determines whether or not a prize is won by the number on the exposed bingo ball (Step S210). When no prize is won, the process flow returns to Step S207. When a prize is won, the special game control unit makes a payout for the JACKPOT (Step S211), and terminates the JACKPOT game.

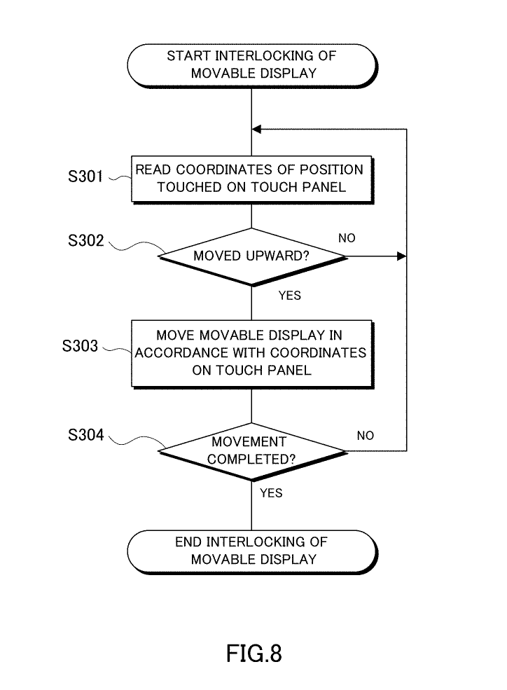

FIG. 8 is a flowchart illustrating an operation of interlocking the movable display. First, when interlocking of the movable display is started, the special game control unit reads the coordinates of a position on the touch panel touched by the player (Step S301). Next, the special game control unit determines whether or not the touch position has moved to the upper side in the front view (Step S302).

In a case where the touch position has not moved to the upper side in the front view, the process flow returns to Step S301. The position of the movable display is moved in accordance with the coordinates of the touch position (Step S303).

Subsequently, the special game control unit determines whether or not the movement of the movable display has been completed (Step S304) and, in a case where the movement has not been completed, the process flow returns to Step S301. In a case where the movement has been completed, the special game control unit terminates the operation of interlocking the movable display.

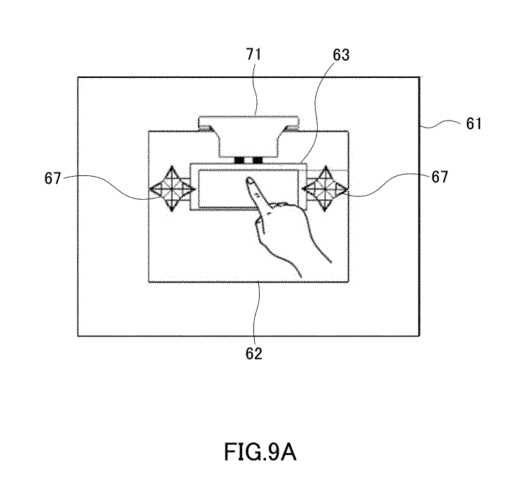

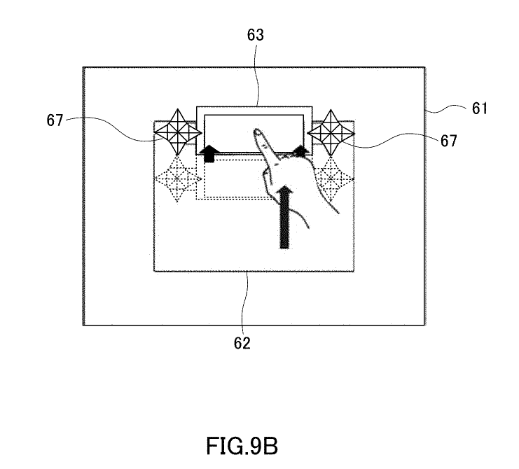

FIGS. 9A and 9B respectively illustrate an exemplary operation of interlocking the movable display. As illustrated in FIG. 9A, when the user touches the touch panel at the position of the movable display 63 and moves the touch position upward as illustrated in FIG. 9B, the movable display 63 also moves upward together with the rotational body 67. The movement is enabled by an operation of the movement module 71 which causes the movable display 63 to slide by the driving power of the stepping motor. As a result, the display of the fixed display 62 which has been hidden behind the movable display 63 is exposed.

(3) Operation when Playing Bonus Game

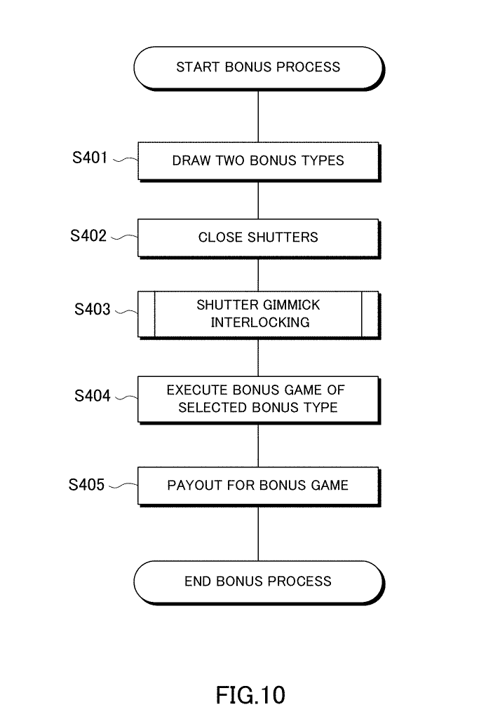

FIG. 10 is a flowchart illustrating an operation of a bonus process. When a prize is won in a bonus game, the special game control unit first draws two bonus types by a lottery (Step S401), and controls the movement module 72 to close the shutters 64a and 64b (Step S402).

Next, the special game control unit performs an operation of shutter gimmick interlocking (Step S403), and prompts the player to select a bonus type. The special game control unit then executes the bonus game of the selected bonus type (Step S404), makes a payout for the bonus game (Step S405), and terminates the bonus process.

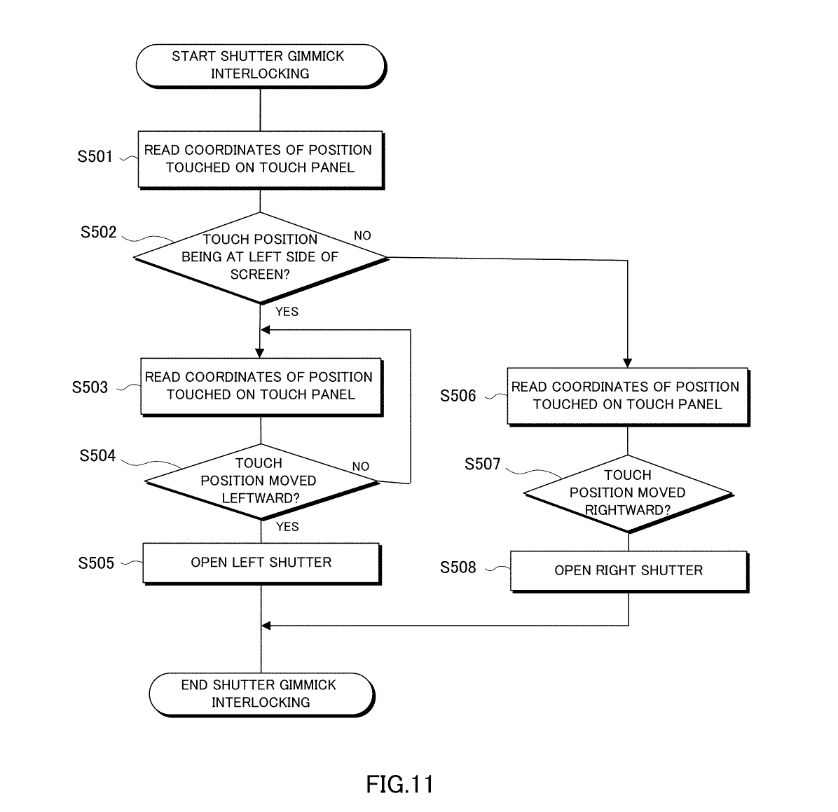

FIG. 11 is a flowchart illustrating an operation of shutter gimmick interlocking. When the shutter gimmick interlocking is started, the special game control unit first reads the coordinates of a position on the touch panel touched by the player (Step S501) and determines whether or not the touch position is at the left side in the front view (Step S502). When the touch position is at the left side in the front view, the special game control unit further reads the coordinates of a position on the touch panel touched by the player (Step S503), and determines whether or not the touch position has moved leftward (Step S504). In a case where the touch position has not moved leftward, the process flow returns to Step S503. In a case where the touch position has moved leftward, the special game control unit opens only the shutter 64a left in the front view (Step S505), and terminates the operation of shutter gimmick interlocking.

When, on the other hand, the position on the touch panel touched at Step S502 is at the right side in the front view, the special game control unit further reads the coordinates of the position on the touch panel touched by the player (Step S506), and determines whether or not the touch position has moved rightward (Step S507). In a case where the touch position has not moved rightward, the process flow returns to Step S506. In a case where the touch position has moved rightward, the special game control unit opens only the shutter 64b right in the front view (Step S508), and terminates the operation of shutter gimmick interlocking.

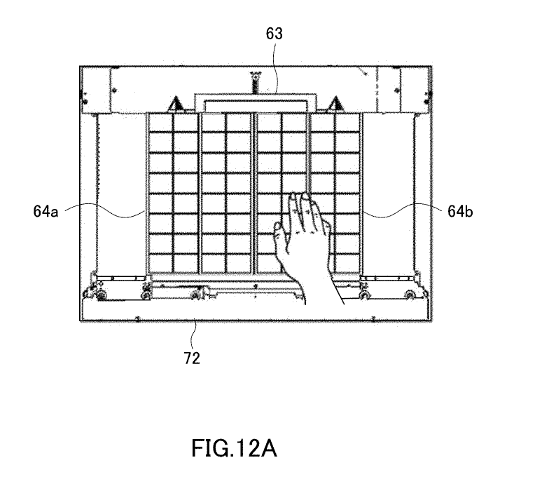

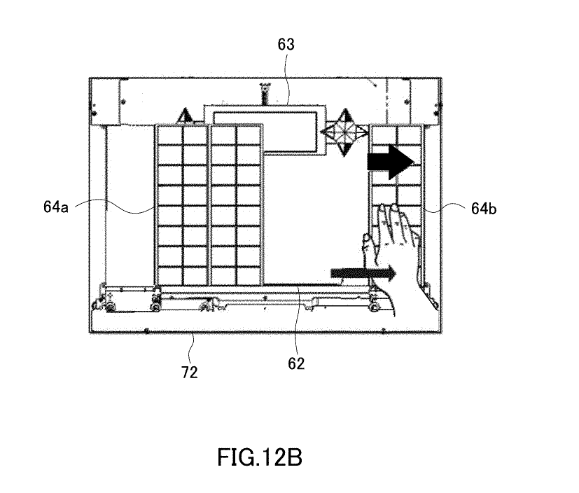

FIGS. 12A and 12B respectively illustrate an exemplary operation of shutter gimmick interlocking. When the user touches the touch panel at a position of the right-side shutter 64b as illustrated in FIG. 12A and moves the touch position rightward as illustrated in FIG. 12B, the shutter 64b also moves rightward interlockedly. The movement is enabled by the operation of the movement module 72 that causes the shutter 64b to slide by driving power of a stepping motor. As a result, the display of the fixed display 62 which has been hidden behind the shutter 64b is exposed.

### Second Embodiment

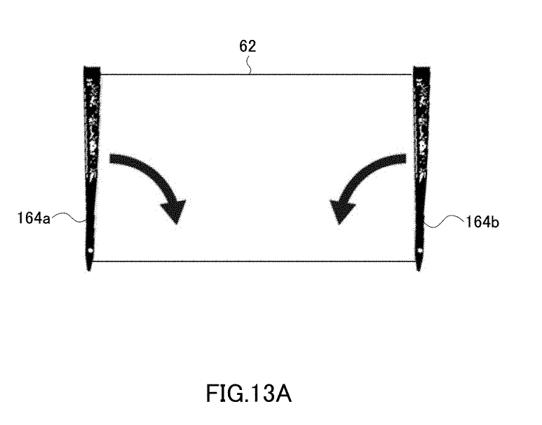

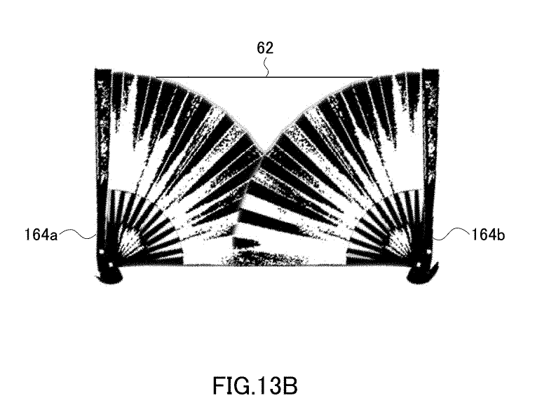

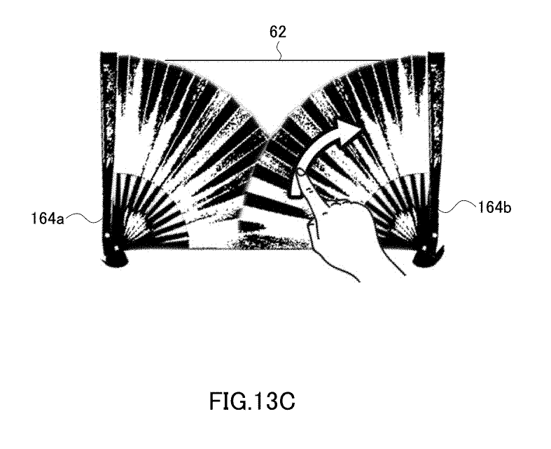

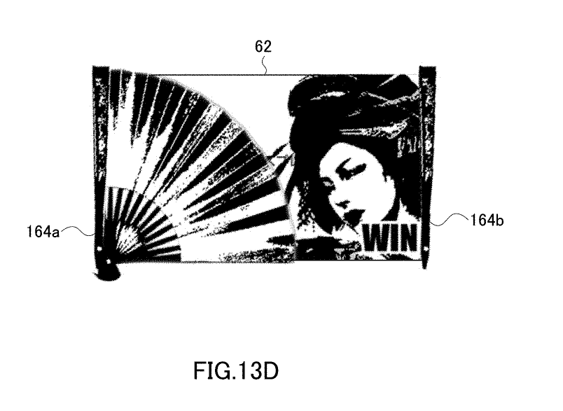

The shutters 64a and 64b provided as shielding units in the aforementioned embodiment may be fan-shaped shields. FIGS. 13A to 13D respectively illustrate an exemplary operation using a fan-shaped shield.

As illustrated in FIG. 13A, fan-shaped shields 164a and 164b in the form of folding fans are usually waiting at the right and left sides in a folded state, respectively, exposing the display of the fixed display 62. When a bonus game which uses a shielding unit is started as illustrated in FIG. 13B, the fan-shaped shields 164a and 164b deform into a spread state, i.e., are spread so as to hide the fixed display 62 from the right and left sides to cover the display thereon.

The fixed display 62 displays the result of the bonus game in a state being covered with the fan-shaped shields 164a and 164b. As illustrated in FIGS. 13C and 13D, when the player places a finger on the touch panel and performs swipe operation of either the fan-shaped shield 164a or 164b by sliding the finger over the touch panel in a direction along the arc of the fan so as to close the fan, the fan-shaped shield 164b, which has been operated, is folded and closed by being interlocked with the operation. The interlocking of the fan-shaped shield 164b exposes the display of the determination of hitting or losing of the bonus game being displayed on the fixed display 62.

### Third Embodiment

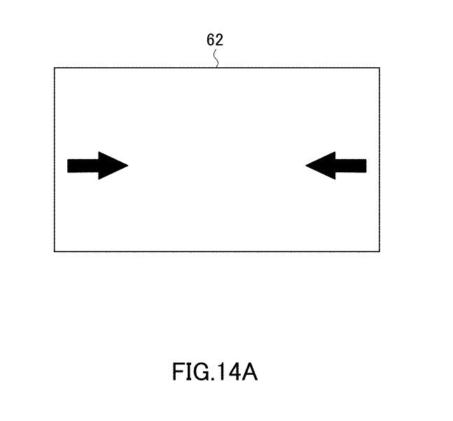

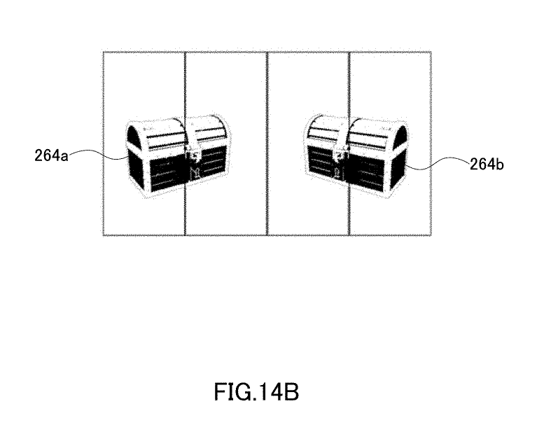

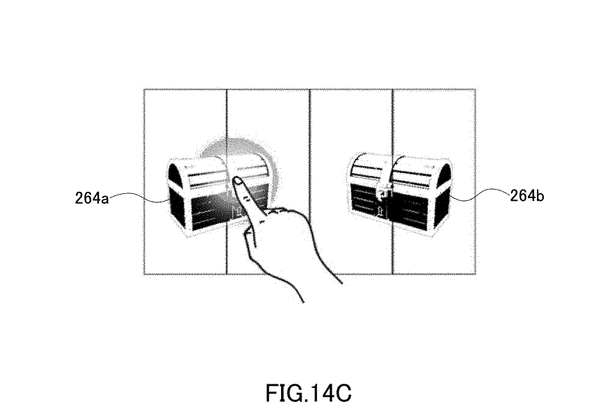

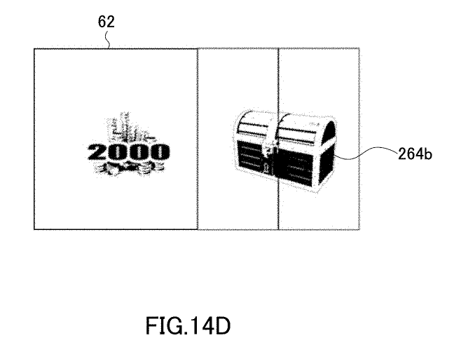

The shielding unit may be a figure. FIGS. 14A to 14D respectively illustrate an exemplary operation using FIGS. 264a and 264b. In the present embodiment, treasure-box FIGS. 264a and 264b are used.

First, as illustrated in FIGS. 14A and 14B, the FIGS. 264a and 264b riding on a rail appear from the right and left to be placed with overlapping on the fixed display 62, whereby the fixed display 62 is hidden.

As illustrated in FIG. 14C, when the player touches the touch panel on one FIG. 264a and slides the finger sideways, the FIG. 264a also moves interlockedly. Subsequently, as illustrated in FIG. 14D, a display image of the fixed display 62 which has been hidden behind the FIG. 264a appears, and it is displayed whether or not a prize is won in the bonus game. The example of FIG. 14D illustrates that 2000 coins have been won.

### Fourth Embodiment

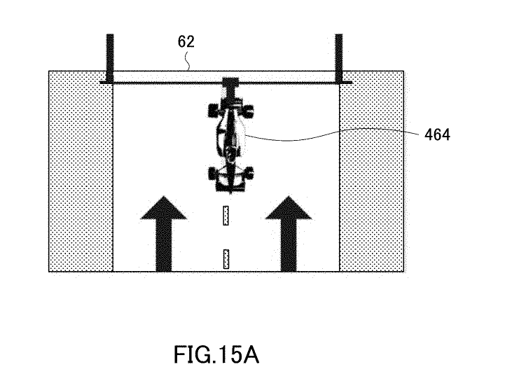

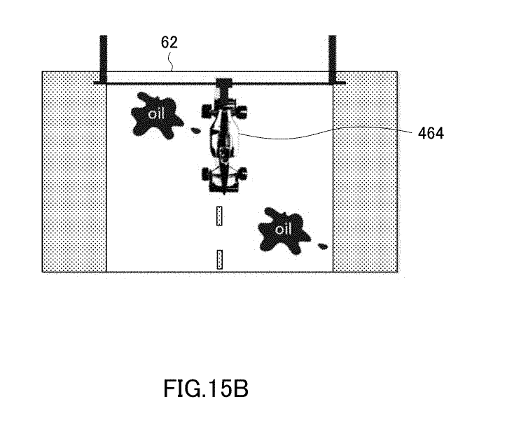

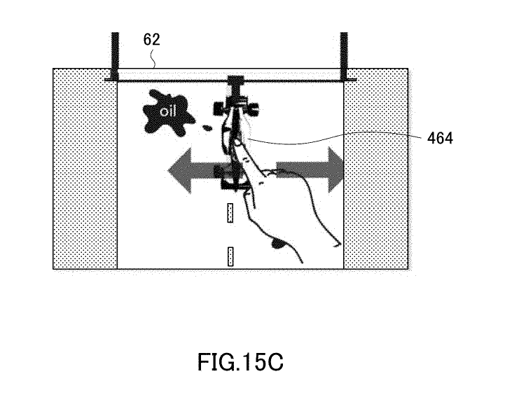

An action game may be executed as the bonus game, which operates the figure of the shielding unit on the display of the fixed display 62. FIGS. 15A to 15C illustrate an exemplary operation of the bonus game.

In the example illustrated in FIGS. 15A to 15C, a racing-car-type FIG. 464 is operatably provided in interlocking with a touch on the touch panel, and the fixed display 62 displays a scrolling ground, presenting the racing car to look like running. It is possible to execute a bonus game of avoiding an obstacle (oil) appearing on the road surface as a display of the fixed display 62, by touching the touch panel with a finger to move the racing-car FIG. 464 sideways interlockedly. It is possible to perform setting which provides a payoff for successfully avoiding all the obstacles and reaching the goal.

### Fifth Embodiment

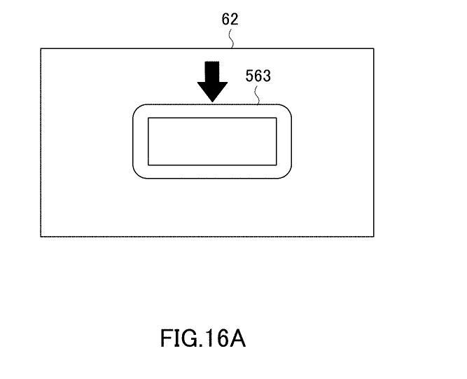

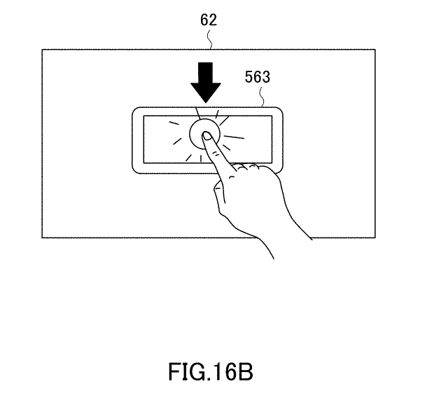

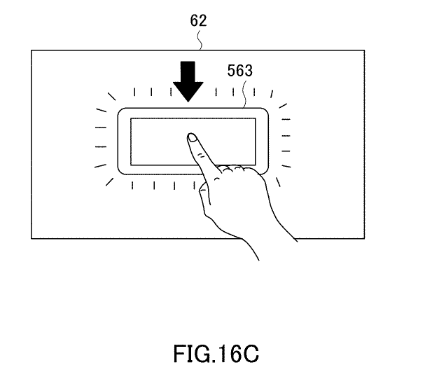

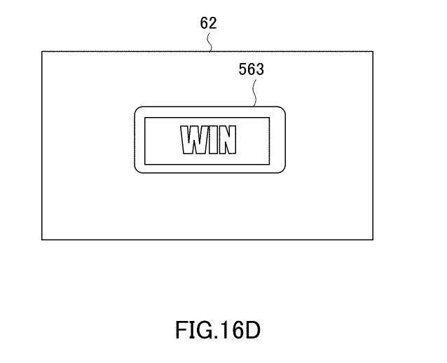

Although the movable display 63 only moves vertically by the touch operation while displaying the display screen in the aforementioned embodiment, the movable display may be provided with other display functions to perform effective presentation. FIGS. 16A to 16D illustrate an exemplary operation using a movable display with LEDs.

In the example illustrated in FIGS. 16A to 16D, LEDs are provided around a movable display 563. There are stick-like LEDs attached around the frame of the movable display 563, the LEDs being set to flicker on and off in response to performing an operation such as touching the touch panel with a finger in a manner touching the movable display 563.

Performing such a display allows to set a difference in the intensity of presentation or the amount of payoff according to the color of LEDs. In addition, a result announcement image may be displayed on the movable display 563 along with flickering of LEDs.

### REFERENCE SIGNS LIST

1 slot machine
2 housing
3b cross-section
6 display unit
8 coin insertion slot
9 bill insertion slot
10 bet button
11 MAX-bet button
12 spin button
13 spin lever
15 coin payout slot
16 coin receiving tray
17 loud speaker
20 payout button
22 help button
23 number-of-payout-coins display unit
24 number-of-retained-coins display unit
30 CPU
31 memory
33 touch panel control board
37 interface board
40 I/O port
61 touch panel
62 fixed display
63 movable display (overlapping unit)
64, 64a, 64b shutter (overlapping unit)
67 rotational body
71, 72 movement module
81 stepping motor
83a pinion
84a rack
83b, 84b coupling member
164a, 164b fan-shaped shield
264a, 264b figure
464 figure
563 movable display

What is claimed is:

1. A slot machine that determines hitting of a prize according to an arrangement of a plurality of symbols in a regular game, the slot machine comprising:
a special game control unit configured to control a special game which is started with winning a prize in the regular game as a trigger;
a fixed display configured to display the special game;
a movable overlapping unit provided in front of the fixed display;
a touch panel provided in the nearest side of a player; and
an interlocking control unit configured to interlock the overlapping unit in accordance with a specific input operation to the touch panel, wherein
the slot machine executes the special game by synchronizing movement of the overlapping unit by the specific input operation and display by the fixed display.

2. The slot machine according to claim 1, wherein
the fixed display displays hitting or losing of a prize in the special game, and
the overlapping unit is moved by the specific input operation so as to expose the display by the fixed display.

3. The slot machine according to claim 1, wherein the overlapping unit is a movable display which guides and displays to a player a specific input operation on the touch panel.

4. The slot machine according to claim 1, wherein the overlapping unit is a shielding unit formed by one or more board members which do not display by themselves.

5. The slot machine according to claim 1, wherein the interlocking control unit determines whether or not a position on the touch panel touched by the player is within a region occupied by the overlapping unit and, when the position is within the region, causes the overlapping unit to follow the movement of the touch position.
